(19) United States
(12) Patent Application Publication
(10) Pub. No.: US 2026/0230948 A1
(43) Pub. Date: Aug. 6, 2026

(54) DEVICES AND METHODS OF COMMUNICATION

(71) Applicant: NEC Corporation, Tokyo (JP)

(72) Inventors: Da WANG, Beijing (CN); Gang WANG, Beijing (CN)

(73) Assignee: NEC Corporation, Tokyo (JP)

(21) Appl. No.: 19/152,597

(22) PCT Filed: Feb. 15, 2023
(86) PCT No.: PCT/CN2023/076102

§ 371 Date: Jul. 31, 2025

(51) Int. Cl. H04W 36/00

(52) U.S. Cl. CPC H04W 36/0058; H04W 36/0072

(57) ABSTRACT

Embodiments of the present disclosure relate to devices and methods of communication. In one aspect, a terminal device receives DCI triggering an RA procedure on a candidate cell in a set of candidate cells allowing LTM, and performs the RA procedure on the candidate cell. Then the terminal device transmits information of the RA procedure comprising at least one of the following: an identity of the candidate cell, or an index of a candidate configuration associated with the candidate cell. In this way, optimization of LTM deployment may be facilitated.

### TECHNICAL FIELD

Embodiments of the present disclosure generally relate to the field of telecommunication, and in particular, to devices and methods of communication for self-organizing network (SON) enhancement on layer 1 (L1)/layer 2 (L2) triggered mobility (LTM).

### BACKGROUND

As known, SON has been introduced to support deployment of system and performance optimization. With mobility enhancement supported, a mobility robustness optimization (MRO) function for SON needs to be further enhanced as well for better network performance.

Currently, it has been proposed to trigger a change or addition or release of a serving cell by a lower-layer signaling such as L1/L2 signaling, which is also referred to as LTM. However, SON enhancement on the LTM is still incomplete and needs to be further developed.

### SUMMARY

In general, embodiments of the present disclosure provide methods, devices and computer storage media of communication for SON enhancement on LTM.

In a first aspect, there is provided a terminal device. The terminal device comprises a processor. The processor is configured to cause the terminal device to: receive downlink control information triggering a random access procedure on a candidate cell in a set of candidate cells allowing LTM; perform the random access procedure on the candidate cell; and transmit information of the random access procedure comprising at least one of the following: an identity of the candidate cell, or an index of a candidate configuration associated with the candidate cell.

In a second aspect, there is provided a terminal device. The terminal device comprises a processor. The processor is configured to cause the terminal device to: receive a configuration for a set of candidate cells allowing LTM; and in accordance with a determination that a failure of a cell switch or a radio link occurs during LTM, transmit information of the failure of the cell switch or the radio link.

In a third aspect, there is provided a terminal device. The terminal device comprises a processor. The processor is configured to cause the terminal device to: receive a medium access control control element indicating a cell switch to a target candidate cell; perform the cell switch to the target candidate cell; and in accordance with a determination that the cell switch is successfully completed, transmit information of the cell switch.

In a fourth aspect, there is provided a method of communication. The method comprises: receiving, at a terminal device, downlink control information triggering a random access procedure on a candidate cell in a set of candidate cells allowing LTM; performing the random access procedure on the candidate cell; and transmitting information of the random access procedure comprising at least one of the following: an identity of the candidate cell, or an index of a candidate configuration associated with the candidate cell.

In a fifth aspect, there is provided a method of communication. The method comprises: receiving, at a terminal device, a configuration for a set of candidate cells allowing LTM; and in accordance with a determination that a failure of a cell switch or a radio link occurs during LTM, transmitting information of the failure of the cell switch or the radio link.

In a sixth aspect, there is provided a method of communication. The method comprises: receiving, at a terminal device, a medium access control control element indicating a cell switch to a target candidate cell; performing the cell switch to the target candidate cell; and in accordance with a determination that the cell switch is successfully completed, transmitting information of the cell switch.

In a seventh aspect, there is provided a computer readable medium having instructions stored thereon. The instructions, when executed on at least one processor, cause the at least one processor to perform the method according to any of the fourth to sixth aspects of the present disclosure.

Other features of the present disclosure will become easily comprehensible through the following description.

### BRIEF DESCRIPTION OF THE DRAWINGS

Through the more detailed description of some embodiments of the present disclosure in the accompanying drawings, the above and other objects, features and advantages of the present disclosure will become more apparent, wherein:

FIG. 1A illustrates an example communication network in which some embodiments of the present disclosure can be implemented;

FIG. 1B illustrates a schematic diagram illustrating network protocol layer entities that may be established for a user plane (UP) protocol stack at devices according to some embodiments of the present disclosure;

FIG. 1C illustrates a schematic diagram illustrating network protocol layer entities that may be established for a control plane (CP) protocol stack at devices according to some embodiments of the present disclosure;

FIG. 1D illustrates a schematic diagram illustrating a process of LTM in which some embodiments of the present disclosure can be implemented;

FIG. 2 illustrates a schematic diagram illustrating a process for reporting information of a random access (RA) procedure on a candidate cell according to embodiments of the present disclosure;

FIG. 3 illustrates a schematic diagram illustrating a process for reporting a failure during LTM according to embodiments of the present disclosure;

FIG. 4 illustrates a schematic diagram illustrating reported time information according to embodiments of the present disclosure;

FIG. 5 illustrates a schematic diagram illustrating a process for reporting a success cell switch during LTM according to embodiments of the present disclosure;

FIG. 6 illustrates an example method of communication implemented at a terminal device in accordance with some embodiments of the present disclosure;

FIG. 7 illustrates another example method of communication implemented at a terminal device in accordance with some embodiments of the present disclosure;

FIG. 8 illustrates still another example method of communication implemented at a terminal device in accordance with some embodiments of the present disclosure; and

FIG. 9 is a simplified block diagram of a device that is suitable for implementing embodiments of the present disclosure.

Throughout the drawings, the same or similar reference numerals represent the same or similar element.

### DETAILED DESCRIPTION

Principle of the present disclosure will now be described with reference to some embodiments. It is to be understood that these embodiments are described only for the purpose of illustration and help those skilled in the art to understand and implement the present disclosure, without suggesting any limitations as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

As used herein, the term ‘terminal device’ refers to any device having wireless or wired communication capabilities. Examples of the terminal device include, but not limited to, user equipment (UE), personal computers, desktops, mobile phones, cellular phones, smart phones, personal digital assistants (PDAs), portable computers, tablets, wearable devices, internet of things (IOT) devices, Ultra-reliable and Low Latency Communications (URLLC) devices, Internet of Everything (IoE) devices, machine type communication (MTC) devices, device on vehicle for V2X communication where X means pedestrian, vehicle, or infrastructure/network, devices for Integrated Access and Backhaul (IAB), Space borne vehicles or Air borne vehicles in Non-terrestrial networks (NTN) including Satellites and High Altitude Platforms (HAPs) encompassing Unmanned Aircraft Systems (UAS), extended Reality (XR) devices including different types of realities such as Augmented Reality (AR), Mixed Reality (MR) and Virtual Reality (VR), the unmanned aerial vehicle (UAV) commonly known as a drone which is an aircraft without any human pilot, devices on high speed train (HST), or image capture devices such as digital cameras, sensors, gaming devices, music storage and playback appliances, or Internet appliances enabling wireless or wired Internet access and browsing and the like. The ‘terminal device’ can further has ‘multicast/broadcast’ feature, to support public safety and mission critical, V2X applications, transparent IPv4/IPv6 multicast delivery, IPTV, smart TV, radio services, software delivery over wireless, group communications and IoT applications. It may also incorporated one or multiple Subscriber Identity Module (SIM) as known as Multi-SIM. The term “terminal device” can be used interchangeably with a UE, a mobile station, a subscriber station, a mobile terminal, a user terminal or a wireless device.

The term “network device” refers to a device which is capable of providing or hosting a cell or coverage where terminal devices can communicate. Examples of a network device include, but not limited to, a Node B (NodeB or NB), an evolved NodeB (eNodeB or eNB), a next generation NodeB (gNB), a transmission reception point (TRP), a remote radio unit (RRU), a radio head (RH), a remote radio head (RRH), an IAB node, a low power node such as a femto node, a pico node, a reconfigurable intelligent surface (RIS), and the like.

The terminal device or the network device may have Artificial intelligence (AI) or Machine learning capability. It generally includes a model which has been trained from numerous collected data for a specific function, and can be used to predict some information.

The terminal or the network device may work on several frequency ranges, e.g. FR1 (410 MHz to 7125 MHz), FR2 (24.25 GHz to 71 GHz), frequency band larger than 100 GHz as well as Tera Hertz (THz). It can further work on licensed/unlicensed/shared spectrum. The terminal device may have more than one connections with the network devices under Multi-Radio Dual Connectivity (MR-DC) application scenario. The terminal device or the network device can work on full duplex, flexible duplex and cross division duplex modes.

The embodiments of the present disclosure may be performed in test equipment, e.g. signal generator, signal analyzer, spectrum analyzer, network analyzer, test terminal device, test network device, channel emulator.

In one embodiment, the terminal device may be connected with a first network device and a second network device. One of the first network device and the second network device may be a master node and the other one may be a secondary node. The first network device and the second network device may use different radio access technologies (RATs). In one embodiment, the first network device may be a first RAT device and the second network device may be a second RAT device. In one embodiment, the first RAT device is eNB and the second RAT device is gNB. Information related with different RATs may be transmitted to the terminal device from at least one of the first network device or the second network device. In one embodiment, first information may be transmitted to the terminal device from the first network device and second information may be transmitted to the terminal device from the second network device directly or via the first network device. In one embodiment, information related with configuration for the terminal device configured by the second network device may be transmitted from the second network device via the first network device. Information related with reconfiguration for the terminal device configured by the second network device may be transmitted to the terminal device from the second network device directly or via the first network device.

As used herein, the singular forms ‘a’, ‘an’ and ‘the’ are intended to include the plural forms as well, unless the context clearly indicates otherwise. The term ‘includes’ and its variants are to be read as open terms that mean ‘includes, but is not limited to.’ The term ‘based on’ is to be read as ‘at least in part based on.’ The term ‘one embodiment’ and ‘an embodiment’ are to be read as ‘at least one embodiment.’ The term ‘another embodiment’ is to be read as ‘at least one other embodiment.’ The terms ‘first,’ ‘second,’ and the like may refer to different or same objects. Other definitions, explicit and implicit, may be included below.

In some examples, values, procedures, or apparatus are referred to as ‘best,’ ‘lowest,’ ‘highest,’ ‘minimum,’ ‘maximum,’ or the like. It will be appreciated that such descriptions are intended to indicate that a selection among many used functional alternatives can be made, and such selections need not be better, smaller, higher, or otherwise preferable to other selections.

In the context of the present disclosure, the term “a cell switch” may be interchangeably used with “reconfiguration with sync for secondary cell group (SCG) or master cell group (MCG)” or “a cell change”. The term “PSCell” refers to a SpCell of a SCG the term “PCell” refers to a SpCell of a MCG, and the term “SpCell” refers to a primary cell of a SCG or MCG The term “SCell” refers to a secondary cell. The term “lower-layer signaling” may be interchangeably used with “L1/L2 signaling”. The term “radio resource control (RRC) reconfiguration” may be interchangeably used with “RRC reconfiguration message”. The term “candidate cell” may be interchangeably used with “LTM candidate cell”. The term “target cell” may be interchangeably used with “target candidate cell”, “candidate target cell”, or “LTM target candidate cell”.

SON, which encompasses solutions for network self-configuration and self-optimization, was introduced to support deployment of system and performance optimization.

As SON features, physical cell identity (PCI) allocation and automatic neighbour relations (ANR) were introduced already in the third generation partnership project (3GPP) Release 8, while the term “SON” was introduced in 3GPP Release 9. Success of these two features encouraged further study on the topic and resulted in enabled 3 SON features: mobility robustness optimization (MRO), mobility load balancing (MLB) and random access channel (RACH) optimization. The features MRO and MLB were further enhanced in following releases to match increasing long-term evolution (LTE) complexity. Besides ANR, MRO, MLB and RACH optimization, also other features enabling particular aspects of network self-optimization are discussed and These SON features are performed based on the statistic of massive data from network and user equipment (UE), which can be regarded as the pioneers of BigData usage in radio access network (RAN).

With mobility enhancement supported, the MRO function for SON needs to be further enhanced as well for better network performance.

Embodiments of the present disclosure provide solutions of communication for at least SON enhancement on LTM. In one aspect, a terminal device receives downlink control information (DCI) triggering an RA procedure on a candidate cell in a set of candidate cells allowing LTM. The terminal device performs the RA procedure on the candidate cell and transmits information of the RA procedure. In some embodiments, the information of the random access procedure may comprise at least one of the following: an identity of the candidate cell, or an index of a candidate configuration associated with the candidate cell. In this way, information of an unsuccessful or successful RA on a LTM candidate cell may be reported to a network, and SON features may be enhanced for the network to optimize LTM deployment.

In another aspect, a terminal device receives a configuration for a set of candidate cells allowing LTM. If a failure of a cell switch or a radio link occurs during the LTM, the terminal device transmits information of the failure of the cell switch or the radio link. In this way, information of a failure during LTM may be reported to a network, and SON features may be enhanced for the network to optimize LTM deployment.

In still another aspect, a terminal device receives a medium access control control element (MAC CE) indicating a cell switch to a target candidate cell, and performs the cell switch to the target candidate cell. If the cell switch is successfully completed, the terminal device transmits information of the cell switch. In this way, information of a successful cell switch during LTM may be reported to a network, and SON features may be enhanced for the network to optimize LTM deployment.

Principles and implementations of the present disclosure will be described in detail below with reference to the figures.

### Example of Communication Network

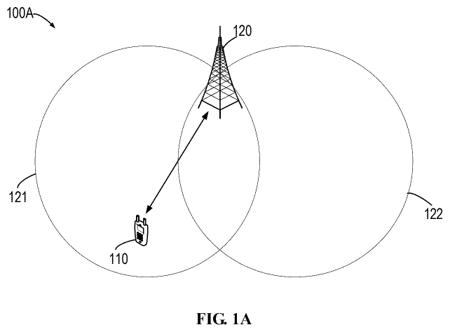

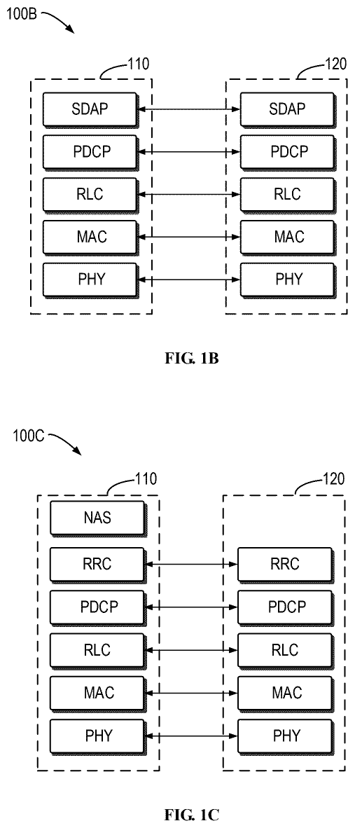

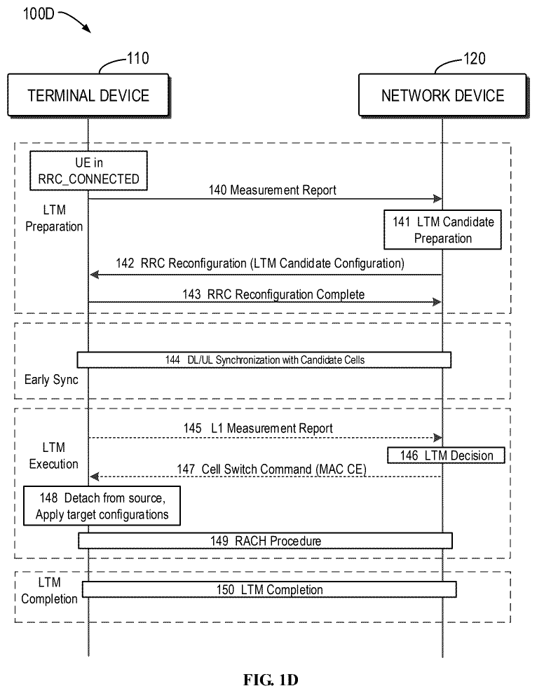

FIG. 1A illustrates a schematic diagram of an example communication network 100A in which some embodiments of the present disclosure can be implemented. As shown in FIG. 1A, the communication network 100A may include a terminal device 110 and a network device 120. The network device 120 provides a plurality of cells (cells 121 and 122 as shown) to serve a terminal device.

It is to be understood that the number of devices or cells in FIG. 1A is given for the purpose of illustration without suggesting any limitations to the present disclosure. The communication network 100A may include any suitable number of network devices and/or terminal devices and/or cells adapted for implementing implementations of the present disclosure.

As shown in FIG. 1A, the terminal device 110 may communicate with the network device 120 via a channel such as a wireless communication channel. The communications in the communication network 100A may conform to any suitable standards including, but not limited to, Global System for Mobile Communications (GSM), Long Term Evolution (LTE), LTE-Evolution, LTE-Advanced (LTE-A), New Radio (NR), Wideband Code Division Multiple Access (WCDMA), Code Division Multiple Access (CDMA), GSM EDGE Radio Access Network (GERAN), Machine Type Communication (MTC) and the like. The embodiments of the present disclosure may be performed according to any generation communication protocols either currently known or to be developed in the future. Examples of the communication protocols include, but not limited to, the first generation (1G), the second generation (2G), 2.5G, 2.75G, the third generation (3G), the fourth generation (4G), 4.5G, the fifth generation (5G) communication protocols, 5.5G, 5G-Advanced networks, or the sixth generation (6G) networks.

Communication in a direction from the terminal device 110 towards the network device 120 is referred to as uplink (UL) communication, while communication in a reverse direction from the network device 120 towards the terminal device 110 is referred to as downlink (DL) communication. The terminal device 110 can move amongst the cells of the network device 120 and possibly other network devices. In UL communication, the terminal device 110 may transmit UL data and control information to the network device 120 via a UL channel. In DL communication, the network device 120 may transmit DL data and control information to the terminal device 110 via a DL channel.

The communications in the communication network 100A can be performed in accordance with UP and CP protocol stacks. Generally speaking, for a communication device (such as a terminal device or a network device), there are a plurality of entities for a plurality of network protocol layers in a protocol stack, which can be configured to implement corresponding processing on data or signaling transmitted from the communication device and received by the communication device. FIG. 1B illustrates a schematic diagram 100B illustrating network protocol layer entities that may be established for UP protocol stack at devices according to some embodiments of the present disclosure. As shown in FIG. 1B, in the UP, each of the terminal device 110 and the network device 120 may comprise an entity for the L1 layer, i.e., an entity for a physical (PHY) layer (also referred to as a PHY entity), and one or more entities for upper layers (L2 and layer 3 (L3) layers, or upper layers) including an entity for a medium access control (MAC) layer (also referred to as a MAC entity), an entity for a radio link control (RLC) layer (also referred to as a RLC entity), an entity for a packet data convergence protocol (PDCP) layer (also referred to as a PDCP entity), and an entity for a service data application protocol (SDAP) layer (also referred to as a SDAP entity, which is established in 5G and higher-generation networks). In some cases, the PHY, MAC, RLC, PDCP, SDAP entities are in a stack structure.

FIG. 1C illustrates a schematic diagram 100C illustrating network protocol layer entities that may be established for CP protocol stack at devices according to some embodiments of the present disclosure. As shown in FIG. 1C, in the CP, each of the terminal device 110 and the network device 120 may comprise an entity for the L1 layer, i.e., an entity for a PHY layer (also referred to as a PHY entity), and one or more entities for upper layers (L2 and L3 layers) including an entity for a MAC layer (also referred to as a MAC entity), an entity for a RLC layer (also referred to as a RLC entity), an entity for a PDCP layer (also referred to as a PDCP entity), and an entity for a radio resource control (RRC) layer (also referred to as a RRC entity). The RRC layer may be also referred to as an access stratum (AS) layer, and thus the RRC entity may be also referred to as an AS entity. As shown in FIG. 1C, the terminal device 110 may also comprise an entity for a non-access stratum (NAS) layer (also referred to as a NAS entity). An NAS layer at the network side is not located in a network device and is located in a core network (CN, not shown). In some cases, these entities are in a stack structure.

In the context of the present disclosure, L1 refers to the PHY layer, L2 refers to the MAC or RLC or PDCP or SDAP layer, and L3 refers to the RRC layer. In the context of the present disclosure, L1 or L2 may also be collectively referred to as a lower-layer, and L3 may also be referred to as a higher-layer. Accordingly, L1 or L2 signaling may be also referred to as a lower-layer signaling, and L3 signaling may be also referred to as a higher-layer signaling.

Generally, communication channels are classified into logical channels, transmission channels and physical channels. The physical channels are channels that the PHY layer actually transmits information. For example, the physical channels may comprise a physical uplink control channel (PUCCH), a physical uplink shared channel (PUSCH), a physical random-access channel (PRACH), a PDCCH, a physical downlink shared channel (PDSCH) and a physical broadcast channel (PBCH).

The transmission channels are channels between the PHY layer and the MAC layer. For example, transmission channels may comprise a broadcast channel (BCH), a downlink shared channel (DL-SCH), a paging channel (PCH), an uplink shared channel (UL-SCH) and an random access channel (RACH).

The logical channels are channels between the MAC layer and the RLC layer. For example, the logical channels may comprise a dedicated control channel (DCCH), a common control channel (CCCH), a paging control channel (PCCH), broadcast control channel (BCCH) and dedicated traffic channel (DTCH).

Generally, channels between the RRC layer and PDCP layer are called as radio bearers. The terminal device 110 may be configured with at least one data radio bearer (DRB) for bearing data plane data and at least one signaling radio bearer (SRB) for bearing control plane data. Four types of SRBs may be defined in a RRC layer, i.e., SRB0, SRB1, SRB2 and SRB3. SRB0 uses a CCCH for RRC connection establishment or re-establishment. SRB1 uses a DCCH and is established when RRC connection is established. SRB2 uses a DCCH and is established during RRC reconfiguration and after initial security activation. SRB3 uses a DCCH and is established between the terminal device 110 and SN when a dual connection is established.

Return to FIG. 1A, in some embodiments, the terminal device 110 may be located within the coverage of cell 121 of the network device 120, and the terminal device 110 may communicate with the network device 120 based on network configuration. In this case, the cell 121 may be referred to as a serving cell of the terminal device 110. The cell 122 may be referred to as a LTM candidate cell of the terminal device 110.

In some embodiments, the terminal device 110 may establish a dual connection (i.e., simultaneous connection) with the network device 120 and another network device (not shown). In some embodiments, the network device 120 may serve as a master node (MN). In these embodiments, the terminal device 110 may communicate with the network device 120 via a set of serving cells. The set of serving cells form a MCG, and a primary cell in the MCG is called as PCell. In some scenarios, the PCell may be changed from the cell 121 to the cell 122. This is called as a handover (HO). In some embodiments, the network device 120 may serve as a secondary node (SN). In these embodiments, the set of serving cells provided by the network device 120 form a SCG, and a primary cell in the SCG is called as PSCell. In some scenarios, the PSCell may be changed from the cell 121 to the cell 122. This is called as a PSCell change.

In some scenarios, the network device 120 may receive L1 measurement reports from the terminal device 110. Based on the L1 measurement reports, the network device 120 may change a serving cell of the terminal device 110 through a MAC CE. This procedure is called as LTM. The network device 120 may prepare one or multiple candidate cells and provides the candidate cell configurations to the terminal device 110 through a RRC message. Then LTM cell switch is triggered by selecting one of the candidate cell configurations as target configuration for LTM by the network device 120.

Cell switch trigger information may be conveyed in a MAC CE, which contains at least a candidate configuration index. Cell-specific, radio bearer, and measurement configurations may be part of an LTM candidate cell configuration. The terminal device 110 may perform contention based random access (CBRA) or contention free random access (CFRA) at a cell switch. The terminal device 110 may also skip a RA procedure if the terminal device 110 doesn't need to acquire TA for a target cell during the cell switch. RACH resources for CFRA may be provided in an RRC configuration.

FIG. 1D illustrates a schematic diagram illustrating a process 100D of LTM in which some embodiments of the present disclosure can be implemented. For the purpose of discussion, the process 100D will be described with reference to FIG. 1A. The process 100D may involve the terminal device 110 and the network device 120 as illustrated in FIG. 1A. The network device 120 may be a MN or SN serving the terminal device 110. In this example, the network device 120 provides a serving cell for the terminal device 110, and also provides one or more candidate cells for the terminal device 110.

As shown in FIG. 1D, at a LTM preparation stage, the terminal device 110 may send 140 a Measurement Report message to the network device 120. The network device 120 may decide 141 to use LTM and initiates LTM candidate preparation. The network device 120 may transmit 142 an RRCReconfiguration message to the terminal device 110 comprising the configuration of one or multiple LTM candidate target cells. The terminal device 110 may store the configuration of LTM candidate target cell(s) and transmit 143 a RRC Reconfiguration Complete message to the network device 120.

At an early synchronization (i.e., early sync) stage, the terminal device 110 may perform 144 DL synchronization and timing advance (TA) acquisition with candidate target cell(s) before receiving the LTM cell switch command.

At a LTM execution stage, the terminal device 110 may perform L1 measurements on the configured LTM candidate target cell(s), and transmits 145 lower-layer measurement reports to the network device 120. The network device 120 may decide 146 to execute LTM cell switch to a target cell, and transmits 147 a MAC CE triggering LTM cell switch by including the candidate configuration index of the target cell. The terminal device 110 may switch 148 to the configuration of the LTM candidate target cell. The terminal device 110 may perform 149 a RA procedure towards the target cell, if TA is not available.

At a LTM completion stage, the terminal device 110 may indicate 150 successful completion of the LTM cell switch towards target cell.

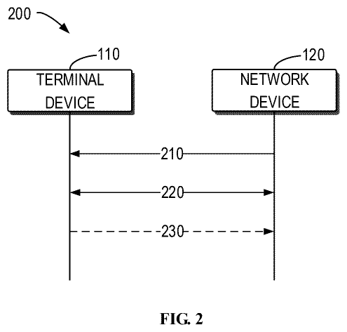

Embodiments of the present disclosure provide a solution of communication for SON enhancement on LTM. Its details will be described with reference to FIGS. 2 to 5.

### Example Implementation of Reporting of Unsuccessful RA for TA Acquisition

In some scenarios, the terminal device 110 may perform an RA procedure for TA acquisition of candidate cell(s) before a cell switch command is received. Conventionally, if an RA problem is indicated from a lower layer, a terminal device may consider a radio link failure (RLF) to be detected for a corresponding cell group. However, for an RA procedure triggered on one LTM candidate cell for early TA acquisition, the conventional behavior is no longer suitable because the LTM candidate cell is not a SpCell yet.

In view of the above, embodiments of the present disclosure provide a solution for reporting information of an RA procedure on a candidate cell. The solution will be described in connection with FIG. 2 below.

FIG. 2 illustrates a schematic diagram illustrating a process 200 of communication for reporting information of an RA procedure on a candidate cell according to embodiments of the present disclosure. For the purpose of discussion, the process 200 will be described with reference to FIG. 1A. The process 200 may involve the terminal device 110 and the network device 120 as illustrated in FIG. 1A. In this example, the network device 120 provides a serving cell (e.g., the cell 121) for the terminal device 110 and also provides one or more candidate cells for the terminal device 110. The serving cell may be SpCell, PCell or PSCell of the terminal device 110.

As shown in FIG. 2, the network device 120 may transmit 210, to the terminal device 110, DCI triggering an RA procedure on a candidate cell in a set of candidate cells allowing LTM. Upon reception of the DCI, the terminal device 110 may perform 220 the RA procedure on the candidate cell. In some embodiments, the RA procedure may fail. In some embodiments, the RA procedure may be successfully completed.

With reference to FIG. 2, the terminal device 110 may transmit 230 information of the RA procedure to the network device 120.

In some embodiments, the terminal device 110 may transmit the information of the RA procedure via a MAC CE. If uplink-shared channel (UL-SCH) resources are available for a new transmission and UL-SCH resources can accommodate a MAC CE plus its subheader, the MAC layer may instruct a multiplexing and assembly procedure to generate the MAC CE. Otherwise, the MAC layer may trigger a scheduling request for the MAC CE. In some embodiments, a MAC layer of the terminal device 110 does not indicate a RA problem to an upper layer (e.g., RRC layer) of terminal device 110.

In some embodiments, the terminal device 110 may transmit the information of the RA procedure via a RRC message. In some embodiments, the MAC layer may indicate to the upper layer (e.g., RRC layer) a RA problem associated with a LTM candidate cell. In some embodiments, the terminal device 110 may transmit the information of the RA procedure via UEAssistanceInformation or any other suitable messages existing or to be developed in the future.

In some embodiments, the terminal device 110 may transmit the information of the RA procedure via uplink control information (UCI).

For transmission of the information of the RA procedure, some example embodiments will be described in connection with Embodiments 1 to 3 below.

### Embodiment 1

In this embodiment, the RA procedure fails. The terminal device may transmit the information of the RA procedure as an indication of the failure of the RA procedure. In some embodiments, when a preamble transmission counter is equal to the maximum number of Random Access Preamble transmission plus one (i.e. PREAMBLE_TRANSMISSION_COUNTER=preambleTransMax+1), the terminal device 110 may consider the RA procedure unsuccessfully completed and transmit the information of RA procedure to the network device 120. In some embodiments, the information of RA procedure may comprise at least one of an identity of the LTM candidate cell or candidate configuration index associated with the LTM candidate cell.

For illustration, an example procedure may be described as below.

UE receives PDCCH to trigger RA procedure on one LTM candidate cell for TA acquisition before receiving the LTM cell switch command, and then performs RA on the LTM candidate cell. During the RA procedure, If a preamble transmission counter is equal to the maximum number of Random Access Preamble transmission plus one (PREAMBLE_TRANSMISSION_COUNTER=preambleTransMax+1), the UE shall perform at least one of: sending information of the RA problem towards the LTM candidate cell to the network; considering the RA procedure is unsuccessfully completed; or not considering a RLF to be detected for the corresponding cell group (i.e., MCG or SCG).

In some embodiments, the information of the RA procedure may comprise an identity of the candidate cell. In some embodiments, the information of the RA procedure may comprise an index of a candidate configuration associated with the candidate cell. It is to be understood that any combination of the above information and any other suitable information may also be feasible.

In this way, UE behavior upon unsuccessful RA on a LTM candidate cell is defined, and SON feature is enhanced for the network to optimize LTM deployment.

### Embodiment 2

In this embodiment, the RA procedure is successfully completed and the RA procedure is contention based. The terminal device may receive, as contention resolution, a UL grant for a transmission to the candidate cell. In this case, the terminal device may discard or ignore the UL grant.

For illustration, an example procedure may be described as below.

In case of the RA on the LTM candidate cell is contention based, for contention resolution, upon reception of PDCCH transmission addressed to the C-RNTI and contains a UL grant for a new transmission, UE shall:
consider this Contention Resolution successful;
stop ra-ContentionResolution Timer;
discard the TEMPORARY_C-RNTI;
discard/ignore the received UL grant;
consider this Random Access procedure successfully completed.

In this way, there is no need to transmit any data to the LTM candidate cell.

### Embodiment 3

In this embodiment, upon successful or failed completed random access procedure on one LTM candidate cell for TA acquisition, the terminal device 110 shall store and send the information of the RA procedure comprising information of success or failure of the RA procedure.

In some embodiments, the information of the RA procedure may comprise an identity of the candidate cell. In some embodiments, the information of the RA procedure may comprise an index of a candidate configuration associated with the candidate cell. In some embodiments, the information of the RA procedure may comprise an identity of a serving cell (e.g., SpCell) of the terminal device 110 when the RA procedure on the LTM candidate cell is triggered. In some embodiments, the information of the RA procedure may comprise an indication of success or failure of the RA procedure. It is to be understood that any combination of the above information and any other suitable information may also be feasible.

In some embodiments, the terminal device 110 may store the information of the RA procedure in a RA report (e.g., VarRA-Report). In some embodiments, the terminal device 110 may store the information of the RA procedure in a dedicated UE variable for RA on the LTM candidate cell. It is to be understood that any other suitable ways are also feasible.

In some embodiments, the terminal device 110 may transmit an indication indicating availability of the information of the RA procedure. In some embodiments, the terminal device 110 may transmit an availability indication of information of an RA procedure associated with at least one LTM candidate cell to the network device 120 if there is such stored information.

In some embodiments, the network device 120 may transmit, to the terminal device 110, a request for obtaining the information of the RA procedure. In some embodiments, the network device 120 may request for the information of RA procedure associated with at least one LTM candidate cell from the terminal device 110 by transmitting UEInformationRequest message with request indication for information of RA procedure associated with at least one LTM candidate cell. Then the terminal device 110 may transmit, to the network device 120, the information of the RA procedure via UEInformationResponse message.

In some embodiments, the terminal device 110 may transmit the information of the RA procedure in an RA report with an RA purpose indicating early acquisition of a TA value. In other words, upon successful or failed completed RA procedure on one LTM candidate cell for TA acquisition, the terminal device 110 may set or include, in an RA report, an RA purpose indicating early TA acquisition for LTM.

So far, a solution for reporting information of an RA procedure on a LTM candidate cell is described. In this way, information of an RA procedure for a LTM candidate cell may be reported to the network and optimization of LTM deployment may be facilitated.

### Example Implementation of Reporting of Failure in LTM

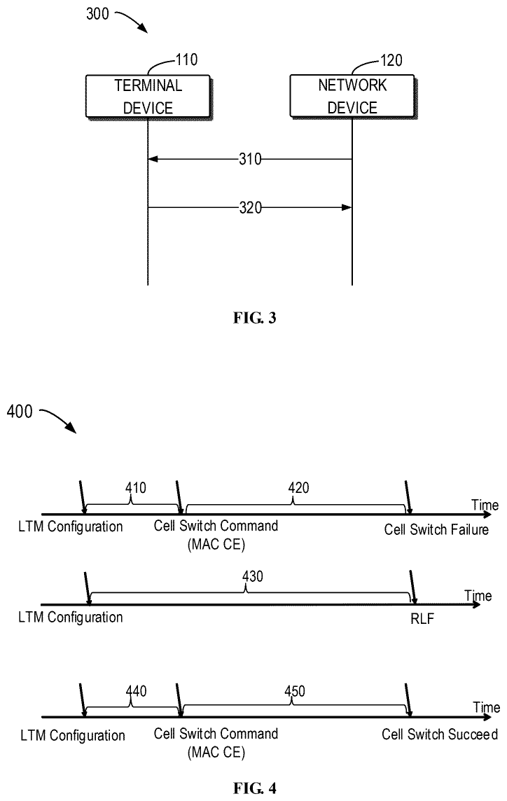

For SON enhancement for LTM, embodiments of the present disclosure also provide a solution for reporting a failure during LTM. The solution will be described below in connection with FIG. 3.

FIG. 3 illustrates a schematic diagram illustrating a process 300 for reporting a failure during LTM according to embodiments of the present disclosure. For the purpose of discussion, the process 300 will be described with reference to FIG. 1A. The process 300 may involve the terminal device 110 and the network device 120 as illustrated in FIG. 1A. In this example, the network device 120 provides a serving cell (e.g., the cell 121) for the terminal device 110, and also provides a target candidate cell (e.g., the cell 122) for the terminal device 110. The serving cell may be SPCell, PCell or PSCell of the terminal device 110.

As shown in FIG. 3, the network device 120 may transmit 310, to the terminal device 110, a configuration for a set of candidate cells allowing LTM.

Upon determination that a cell switch failure (may also refer to as handover failure) or a RLF occurs during LTM, the terminal device 110 may transmit 320 information of the cell switch failure or the RLF to the network device 120. In some embodiments, the terminal device 110 may start a timer upon LTM cell switch. Upon the timer expires, the terminal device 110 may determine that the cell switch failure occurs.

In some embodiments, upon cell switch failure or upon RLF, the terminal device 110 may store or set the information of the cell switch failure or the RLF and report the information of the cell switch failure or the RLF to the network device 120. In some embodiments, the terminal device 110 may store the information of the cell switch failure or the RLF in a RLF report. In some embodiments, the terminal device 110 may store and send the information of the cell switch failure or the RLF in a SCGFailureInformation message. It is to be understood that any other suitable ways are also feasible.

In some embodiments, the information of the cell switch failure or the RLF may comprise an indication that a handover type is LTM. In some embodiments, the information of the cell switch failure or the RLF may comprise an indication of whether the failed cell switch is a subsequent cell switch or not. In some embodiments, the information of the cell switch failure or the RLF may comprise a measurement result of a neighboring cell with an indication of whether the neighboring cell is a candidate cell in the set of candidate cells. In some embodiments, the information of the cell switch failure or the RLF may comprise a list of identities of candidate cells for LTM at the time of the cell switch failure or the RLF. In some embodiments, the information of the cell switch failure or the RLF may comprise an indication of whether an RA procedure is skipped.

In some embodiments where the cell switch failure occurs, the information of the cell switch failure may comprise a period of time elapsed from reception of the configuration until initiation of the cell switch, i.e., a period of time elapsed from reception of the latest LTM configuration until initiation of the last LTM cell switch or reception of a cell switch command (i.e., MAC CE) towards the target cell. FIG. 4 illustrates a schematic diagram 400 illustrating reported time information according to embodiments of the present disclosure. As shown in FIG. 4, a reference sign 410 denotes the period of time elapsed from reception of the configuration until initiation of the cell switch.

In some embodiments where the cell switch failure occurs, the information of the cell switch failure may comprise a period of time elapsed from the initiation of the cell switch until the failure of the cell switch, i.e., a period of time elapsed from reception of the cell switch command (i.e., MAC CE) towards the target cell until the failure of the cell switch. As shown in FIG. 4, a reference sign 420 denotes the period of time elapsed from the initiation of the cell switch until the failure of the cell switch.

In some embodiments where the RLF occurs, the information of the cell switch failure may comprise a period of time elapsed from the reception of the configuration until the RLF, i.e., a period of time elapsed from reception of the latest conditional reconfiguration while connected to a source PCell or PSCell until the RLF. As shown in FIG. 4, a reference sign 430 denotes the period of time elapsed from the reception of the configuration until the RLF.

It is to be understood that any combination of the above information and any other suitable information may also be feasible.

So far, a solution for reporting information of a failure during LTM is described. In this way, information of a cell switch failure and a RLF may be reported to the network and optimization of LTM deployment may be facilitated.

### Example Implementation of Reporting of Successful Cell Switch

For SON enhancement for LTM, embodiments of the present disclosure also provide a solution for reporting a successful cell switch during LTM. The solution will be described below in connection with FIG. 5.

FIG. 5 illustrates a schematic diagram illustrating a process 500 for reporting a success cell switch during LTM according to embodiments of the present disclosure. For the purpose of discussion, the process 500 will be described with reference to FIG. 1A. The process 500 may involve the terminal device 110 and the network device 120 as illustrated in FIG. 1A. In this example, the network device 120 provides a serving cell (e.g., the cell 121) for the terminal device 110, and also provides a target candidate cell (e.g., the cell 122) for the terminal device 110. The serving cell may be SPCell, PCell or PSCell of the terminal device 110.

As shown in FIG. 5, the network device 120 may transmit 510, to the terminal device 110, a MAC CE indicating a cell switch to a target candidate cell. Upon reception of the MAC CE, the terminal device 110 may perform 520 the cell switch to the target candidate cell.

Upon determination that the cell switch is successfully completed, the terminal device 110 may transmit 530 information of the cell switch.

In some embodiments, upon successful completion of the cell switch, the terminal device 110 may store or set the information of the cell switch and report the information of the cell switch to the network device 120. In some embodiments, the terminal device 110 may store the information of the cell switch in a successful handover report (SHR). In some embodiments, the terminal device 110 may store the information of the cell switch in a successful PSCell change/addition report (SPR). It is to be understood that any other suitable ways are also feasible.

In some embodiments, the information of the cell switch may comprise an indication that a handover type is LTM. In some embodiments, the information of the cell switch may comprise an indication of whether the cell switch is a subsequent cell switch or not. In some embodiments, the information of the cell switch may comprise an indication of whether an RA procedure is skipped. In some embodiments, the information of the cell switch may comprise a measurement result of a neighboring cell with an indication of whether the neighboring cell is a candidate cell for LTM.

In some embodiments, the information of the cell switch may comprise a period of time elapsed from reception of a configuration for a set of candidate cells allowing LTM until initiation of the cell switch, i.e., a period of time elapsed from reception of the latest LTM configuration for the target cell until initiation of the cell switch towards the target cell or reception of the cell switch command (i.e., the MAC CE). Still referring to FIG. 4, a reference sign 440 denotes the period of time elapsed from the reception of the configuration for the set of candidate cells allowing LTM until the initiation of the cell switch.

In some embodiments, the information of the cell switch may comprise a period of time elapsed from reception of the MAC CE until successful completion of the cell switch. Still referring to FIG. 4, a reference sign 450 denotes the period of time elapsed from the reception of the MAC CE until the successful completion of the cell switch.

It is to be understood that any combination of the above information and any other suitable information may also be feasible.

So far, a solution for reporting information of a successful cell switch during LTM is described. In this way, information of a successful cell switch may be reported to the network and optimization of LTM deployment may be facilitated.

It is to be understood that the processes 200, 300 and 500 described in connection with FIGS. 2 to 5 may be carried out separately or in any suitable combination.

### Example Implementation of Methods

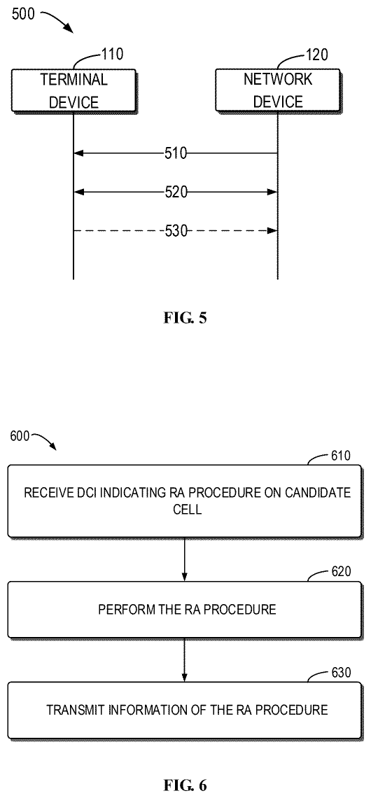

Accordingly, embodiments of the present disclosure provide methods of communication implemented at a terminal device. These methods will be described below with reference to FIGS. 6 to 8.

FIG. 6 illustrates an example method 600 of communication implemented at a terminal device in accordance with some embodiments of the present disclosure. For example, the method 600 may be performed at the terminal device 110 as shown in FIG. 1A. For the purpose of discussion, in the following, the method 600 will be described with reference to FIG. 1A. It is to be understood that the method 600 may include additional blocks not shown and/or may omit some blocks as shown, and the scope of the present disclosure is not limited in this regard.

At block 610, the terminal device 110 receives DCI triggering an RA procedure on a candidate cell in a set of candidate cells allowing LTM.

At block 620, the terminal device 110 performs the RA procedure on the candidate cell.

At block 630, the terminal device 110 transmits information of the RA procedure. In some embodiments, the information of the RA procedure may comprise at least one of the following: an identity of the candidate cell, or an index of a candidate configuration associated with the candidate cell. In some embodiments, the information of the RA procedure may further comprise at least one of the following: an identity of a serving cell of the terminal device 110 when the RA procedure is triggered on the candidate cell, or an indication of success or failure of the RA procedure.

In some embodiments, if the RA procedure fails, the terminal device 110 may transmit the information of the RA procedure as an indication of the failure of the RA procedure.

In some embodiments, the terminal device 110 may transmit the information of the RA procedure via a MAC CE. In some embodiments, the terminal device 110 may transmit the information of the RA procedure via a RRC message. In some embodiments, the terminal device 110 may transmit the information of the RA procedure via UCI.

In some embodiments, the terminal device 110 may store the information of the RA procedure. In some embodiments, the terminal device 110 may transmit an indication indicating availability of the information of the RA procedure. In some embodiments, the terminal device 110 may receive a request for obtaining the information of the RA procedure.

In some embodiments, the terminal device 110 may transmit the information of the RA procedure in an RA report with an RA purpose indicating early acquisition of a TA value.

In some embodiments where the RA procedure is contention based, the terminal device 110 may receive, as contention resolution, a UL grant for a transmission to the candidate cell, and discard the UL grant.

With the method 600, information of an RA procedure for a LTM candidate cell may be reported to a network and optimization of LTM deployment may be facilitated.

FIG. 7 illustrates another example method 700 of communication implemented at a terminal device in accordance with some embodiments of the present disclosure. For example, the method 700 may be performed at the terminal device 110 as shown in FIG. 1A. For the purpose of discussion, in the following, the method 700 will be described with reference to FIG. 1A. It is to be understood that the method 700 may include additional blocks not shown and/or may omit some blocks as shown, and the scope of the present disclosure is not limited in this regard.

At block 710, the terminal device 110 receives a configuration for a set of candidate cells allowing LTM.

At block 720, the terminal device 110 determines that a failure of a cell switch or a radio link occurs during LTM.

At block 730, the terminal device 110 transmits information of the failure of the cell switch or the radio link.

In some embodiments, the information of the failure of the cell switch or the radio link may comprise at least one of the following: an indication that a handover type is LTM, an indication of whether the failed cell switch is a subsequent cell switch or not, a measurement result of a neighboring cell with an indication of whether the neighboring cell is a candidate cell in the set of candidate cells, a list of identities of candidate cells for LTM at the time of the failure, an indication of whether an RA procedure is skipped, a period of time elapsed from reception of the configuration until initiation of the cell switch, a period of time elapsed from the initiation of the cell switch until the failure of the cell switch, or a period of time elapsed from the reception of the configuration until the failure of the radio link.

With the method 700, information of a failure during LTM may be reported to a network and optimization of LTM deployment may be facilitated.

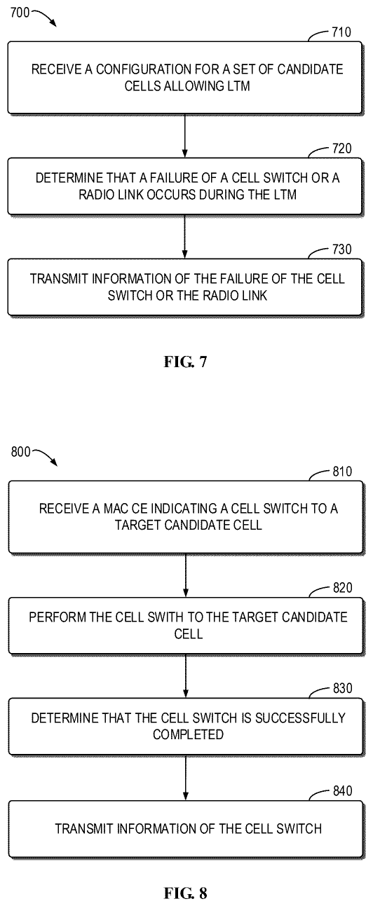

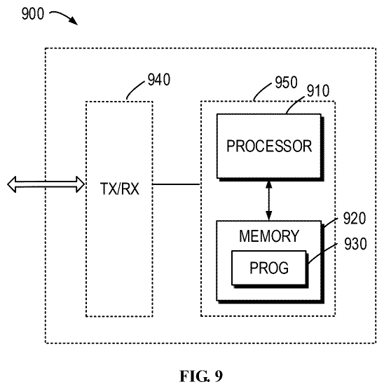

FIG. 8 illustrates still another example method 800 of communication implemented at a terminal device in accordance with some embodiments of the present disclosure. For example, the method 800 may be performed at the terminal device 110 as shown in FIG. 1A. For the purpose of discussion, in the following, the method 800 will be described with reference to FIG. 1A. It is to be understood that the method 800 may include additional blocks not shown and/or may omit some blocks as shown, and the scope of the present disclosure is not limited in this regard.

At block 810, the terminal device 110 receives, from the network device 120, a MAC CE indicating a cell switch to a target candidate cell.

At block 820, the terminal device 110 performs the cell switch to the target candidate cell.

At block 830, the terminal device 110 determines that the cell switch is successfully completed.

At block 840, the terminal device 110 transmits information of the cell switch.

In some embodiments, the information of the cell switch may comprise at least one of the following: an indication that a handover type is LTM, an indication of whether the cell switch is a subsequent cell switch or not, an indication of whether an RA procedure is skipped, a measurement result of a neighboring cell with an indication of whether the neighboring cell is a candidate cell for LTM, a period of time elapsed from reception of a configuration for a set of candidate cells allowing LTM until initiation of the cell switch, or a period of time elapsed from reception of the MAC CE until successful completion of the cell switch.

In some embodiments, the terminal device 110 may store the information of the cell switch.

With the method 800, information of a success cell switch during LTM may be reported to a network and optimization of LTM deployment may be facilitated.

It is to be understood that the operations of methods 600 to 800 correspond to that described in connection with FIGS. 2 to 5, and thus other details are not repeated here for concise.

### Example Implementation of Devices and Apparatuses

FIG. 9 is a simplified block diagram of a device 900 that is suitable for implementing embodiments of the present disclosure. The device 900 can be considered as a further example implementation of the terminal device 110 or the network device 120 as shown in FIG. 1A. Accordingly, the device 900 can be implemented at or as at least a part of the terminal device 110 or the network device 120.

As shown, the device 900 includes a processor 910, a memory 920 coupled to the processor 910, a suitable transmitter (TX) and receiver (RX) 940 coupled to the processor 910, and a communication interface coupled to the TX/RX 940. The memory 910 stores at least a part of a program 930. The TX/RX 940 is for bidirectional communications. The TX/RX 940 has at least one antenna to facilitate communication, though in practice an Access Node mentioned in this application may have several ones. The communication interface may represent any interface that is necessary for communication with other network elements, such as X2/Xn interface for bidirectional communications between eNBs/gNBs, S1/NG interface for communication between a Mobility Management Entity (MME)/Access and Mobility Management Function (AMF)/SGW/UPF and the eNB/gNB, Un interface for communication between the eNB/gNB and a relay node (RN), or Uu interface for communication between the eNB/gNB and a terminal device.

The program 930 is assumed to include program instructions that, when executed by the associated processor 910, enable the device 900 to operate in accordance with the embodiments of the present disclosure, as discussed herein with reference to FIGS. 1A to 8. The embodiments herein may be implemented by computer software executable by the processor 910 of the device 900, or by hardware, or by a combination of software and hardware. The processor 910 may be configured to implement various embodiments of the present disclosure. Furthermore, a combination of the processor 910 and memory 920 may form processing means 950 adapted to implement various embodiments of the present disclosure.

The memory 920 may be of any type suitable to the local technical network and may be implemented using any suitable data storage technology, such as a non-transitory computer readable storage medium, semiconductor based memory devices, magnetic memory devices and systems, optical memory devices and systems, fixed memory and removable memory, as non-limiting examples. While only one memory 920 is shown in the device 900, there may be several physically distinct memory modules in the device 900. The processor 910 may be of any type suitable to the local technical network, and may include one or more of general purpose computers, special purpose computers, microprocessors, digital signal processors (DSPs) and processors based on multicore processor architecture, as non-limiting examples. The device 900 may have multiple processors, such as an application specific integrated circuit chip that is slaved in time to a clock which synchronizes the main processor.

In some embodiments, a terminal device comprises a circuitry configured to: receive downlink control information triggering a random access procedure on a candidate cell in a set of candidate cells allowing layer 1 or layer 2 triggered mobility; perform the random access procedure on the candidate cell; and transmit information of the random access procedure comprising at least one of the following: an identity of the candidate cell, or an index of a candidate configuration associated with the candidate cell.

In some embodiments, a terminal device comprises a circuitry configured to: receive a configuration for a set of candidate cells allowing layer 1 or layer 2 triggered mobility; and in accordance with a determination that a failure of a cell switch or a radio link occurs during the layer 1 or layer 2 triggered mobility, transmit information of the failure of the cell switch or the radio link.

In some embodiments, a terminal device comprises a circuitry configured to: receive a medium access control control element indicating a cell switch to a target candidate cell; perform the cell switch to the target candidate cell; and in accordance with a determination that the cell switch is successfully completed, transmit information of the cell switch.

The term “circuitry” used herein may refer to hardware circuits and/or combinations of hardware circuits and software. For example, the circuitry may be a combination of analog and/or digital hardware circuits with software/firmware. As a further example, the circuitry may be any portions of hardware processors with software including digital signal processor(s), software, and memory(ies) that work together to cause an apparatus, such as a terminal device or a network device, to perform various functions. In a still further example, the circuitry may be hardware circuits and or processors, such as a microprocessor or a portion of a microprocessor, that requires software/firmware for operation, but the software may not be present when it is not needed for operation. As used herein, the term circuitry also covers an implementation of merely a hardware circuit or processor(s) or a portion of a hardware circuit or processor(s) and its (or their) accompanying software and/or firmware.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representation, it will be appreciated that the blocks, apparatus, systems, techniques or methods described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the process or method as described above with reference to FIGS. 1A to 8. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

The above program code may be embodied on a machine readable medium, which may be any tangible medium that may contain, or store a program for use by or in connection with an instruction execution system, apparatus, or device. The machine readable medium may be a machine readable signal medium or a machine readable storage medium. A machine readable medium may include but not limited to an electronic, magnetic, optical, electromagnetic, infrared, or semiconductor system, apparatus, or device, or any suitable combination of the foregoing. More specific examples of the machine readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in language specific to structural features and/or methodological acts, it is to be understood that the present disclosure defined in the appended claims is not necessarily limited to the specific features or acts described above. Rather, the specific features and acts described above are disclosed as example forms of implementing the claims.

1-12. (canceled)

13. A method performed by a terminal device, comprising:
performing a layer 1/layer 2 triggered mobility (LTM) cell switch procedure;
upon successful completion of the LTM cell switch procedure, including, in a successful handover report, information indicating whether a random access procedure is skipped; and
transmitting the successful handover report.

14. The method of claim 13, further comprising:
upon a failure of the LTM cell switch procedure, including, in a radio link failure (RLF) report, information indicating a handover type is LTM; and
transmitting the RLF report.

15. The method of claim 13, further comprising:
upon successfully performing a random access procedure towards a target cell for LTM cell switch, including, in a random access report, information indicating that purpose of executing the random access procedure is for LTM cell switch; and
transmitting the random access report.

16. A method performed by a network device, comprising:
transmitting a layer 1/layer 2 triggered mobility (LTM) cell switch command in MAC CE to trigger a LTM cell switch procedure; and
receiving a successful handover report including information indicating whether a random access procedure is skipped, in response to the LTM cell switch procedure being successfully completed.

17. The method of claim 16, further comprising:
receiving a radio link failure (RLF) report including, information indicating a handover type is LTM, in response to the LTM cell switch procedure being failed.

18. The method of claim 16, further comprising:
receiving a random access report including, information indicating that purpose of executing a random access procedure is for LTM cell switch, in response to the random access procedure towards a target cell for LTM cell switch being successfully performed.

19. A terminal device, comprising a processor configured to:
perform a layer 1/layer 2 triggered mobility (LTM) cell switch procedure;
upon successful completion of the LTM cell switch procedure, including, in a successful handover report, information indicating whether a random access procedure is skipped; and
transmit the successful handover report.

20. The terminal device of claim 19, wherein the processor is further configured to:
upon a failure of the LTM cell switch procedure, include, in a radio link failure (RLF) report, information indicating a handover type is LTM; and
transmit the RLF report.

21. The terminal device of claim 19, wherein the processor is further configured to:
upon successfully performing a random access procedure towards a target cell for LTM cell switch, include, in a random access report, information indicating that purpose of executing the random access procedure is for LTM cell switch; and
transmit the random access report.
